(19) United States
(12) Patent Application Publication
(10) Pub. No.: US 2014/0370979 A1
(43) Pub. Date: Dec. 18, 2014

(54) Using Metadata to Enhance Videogame-Generated Videos

(71) Applicant: Microsoft Corporation, Redmond, WA (US)

(72) Inventors: Jessica Ellen Zahn, Redmond, WA (US); Ramon Zarazua Borri, Redmond, WA (US); Stephen R. Husak, Glen Allen, VA (US); Alvin Y. Chen, Bellevue, WA (US); Daniel C. Broekman, Bellevue, WA (US)

(21) Appl. No.: 13/918,713

(22) Filed: Jun. 14, 2013

(51) Int. Cl. A63F 13/00

(52) U.S. Cl. CPC A63F 13/00
USPC 463/31

(57) ABSTRACT

One or more aspects of the subject disclosure are directed towards providing video content that was generated during the playing of a video game to subsequent game players. Event metadata is generated during game play, while video content (e.g., a clip or clips) of that game play is generated. The event metadata is associated with the video content. Thereafter, the video content may be located by a search based upon the associated metadata.

### BACKGROUND

Online entertainment (including video game) services such as Xbox® LIVE offer many features to users. One contemporary feature is to generate game video clips on behalf of users during game play.

Over time, the user-generated content clips for one user's own game play may become numerous. A gallery may be a suitable way to organize and access such clips if the number of clips is small, but is likely inadequate for most users as the number of clips increases. If friends of that user also have clips that the user may access, the available number of clips will be overwhelming for gallery-style organization and access. Still further, clips may be available from users in general, whereby the number of available clips may be on the order of millions. In such large numbers, there is no way for a user to know what videos are the most interesting and relevant at a given time.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, one or more of various aspects of the subject matter described herein are directed towards returning relevant or otherwise desired videos to users, in which the videos were generated during game play. One or more aspects are directed towards receiving event metadata corresponding to game play for which a video is generated. Video-related metadata of the video is located, and at least some of the event metadata is associated with the video-related metadata of the video.

In one or more aspects, a video and event metadata connector is configured to associate metadata events corresponding to video game play with video content generated during that game play. A video locator queries for one or more video identifiers that match a request for video content based upon event metadata that is associated with the video content by the video and event metadata connector.

One or more aspects are directed towards receiving a request for video content that was generated during the playing of a videogame, and searching for the video content based upon one or more search criteria provided via the request and event metadata that was produced during playing of the video game. One or more video identifiers of video having event metadata that matches the one or more search criteria are returned in response to the request.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 is a block diagram representing example components configured to associate game-related event metadata with videos generated during playing of the game, according to one or more example implementations.

FIG. 2 is a block diagram representing example components configured to search for video content based upon associated game-related event metadata, according to one or more example implementations.

FIG. 3 is a representation of how video content retrieved based upon metadata may be used in a game context, according to one or more example implementations.

FIG. 4 is a flow diagram representing example steps that may be taken to associate game-related event metadata with videos that were generated during playing of the game, according to one or more example implementations.

FIG. 5 is a flow diagram representing example steps that may be taken to search for and retrieve video content using search criteria against associated game-related event metadata, according to one or more example implementations.

FIG. 6 is a block diagram representing an exemplary non-limiting computing system or operating environment, in the form of a gaming system, into which one or more aspects of various embodiments described herein can be implemented.

### DETAILED DESCRIPTION

Various aspects of the technology described herein are generally directed towards associating metadata that is generated during game play with a video clip (or clips) of that game play; thereafter, clips may be located by a search based upon the associated metadata. In this way, for example, a clip that is relevant, desired and/or otherwise appropriate for a user may be located for the user via the metadata as needed.

It should be understood that any of the examples herein are non-limiting. For example, video other than game play, such as television recording, movies and personal video may benefit from the technology described herein. As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used various ways that provide benefits and advantages in computing, video games and video content in general.

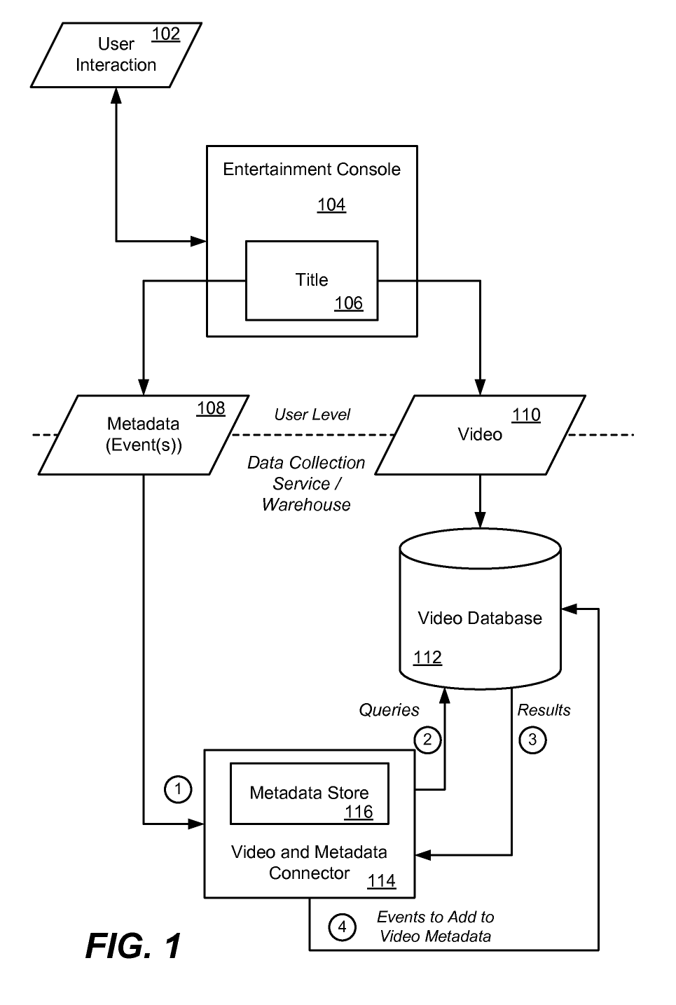

FIG. 1 is a block diagram representing example components that may be used to associate metadata with video (including any audio) generated during game play. As a user interacts (block 102) with an entertainment (e.g., gaming) console 104, a “title” 106 (synonymous with a video game) outputs metadata 108 and generates video 110 in the form of one or more video clips. The metadata may be in any suitable schema, and in general may be ongoing and relatively continuous during the execution of the game The video clips are stored in a video database 112 or other suitable data store.

In general, some contemporary titles are written so as to collect and produce metadata related to the game play, including metadata describing what users are doing, where they are in their games, what inventory or abilities they have, and so on. Described herein is connecting at least some of that metadata with the game video or video. This allows querying of videos by the metadata, whereby, for example, developers can create experiences that showcase or otherwise use videos in contextually relevant scenarios for a user currently playing that game.

As used herein, a video may comprise one or more clips or other subsections, and/or a game for which video is generated may be broken up into multiple videos. The metadata may be used differentiate between subsections of a larger video, between clips that make up a video, and so on. In this way, for example, a user may still be playing a game and be able to retrieve video from earlier in that game, e.g., in an almost live replay scenario, and/or from another person's video, such as a friend. Each video has its own video identifier (ID) and a user ID corresponding to the player for whom the video is generated.

As represented in FIG. 1, at video creation time, metadata events 108 (arrow one (1)) containing relevant current information are sent to a data collection service/warehouse (e.g., a data platform), and for example received at a component or the like shown as a video and metadata connector 114. Each event includes (and thus may be correlated with) the specific video 110 based on the user ID and the video ID, as well as possibly other information, e.g., Title ID. The video and metadata connector 114 stores each event in a metadata store 116 or the like Examples of some events that may be used to provide metadata are listed below.

At a suitable time, such as after the video ends, the video and metadata connector 114 (or optionally a different component) writes queries to run in the metadata store 116 to find which events occurred between the video's start and end time for that user. As represented by arrows two (2) through four (4), those events and their related metadata are added to (or otherwise associated/connected with) the corresponding video's metadata by querying the video database 112. Note that not all received game-related events/metadata need be added to the video's metadata; only those relevant to video may be maintained for retrieval purposes, for example.

It should be noted that performing the association at the data collection service/warehouse level is only one implementation. It is feasible for the title or other console code to perform the association while the game is being played and the video is being generated. For example, events including metadata may be written with timestamps to a data structure that accompanies the video content data. In general, the association may occur at the user level, at the data platform level, or at some combination thereof.

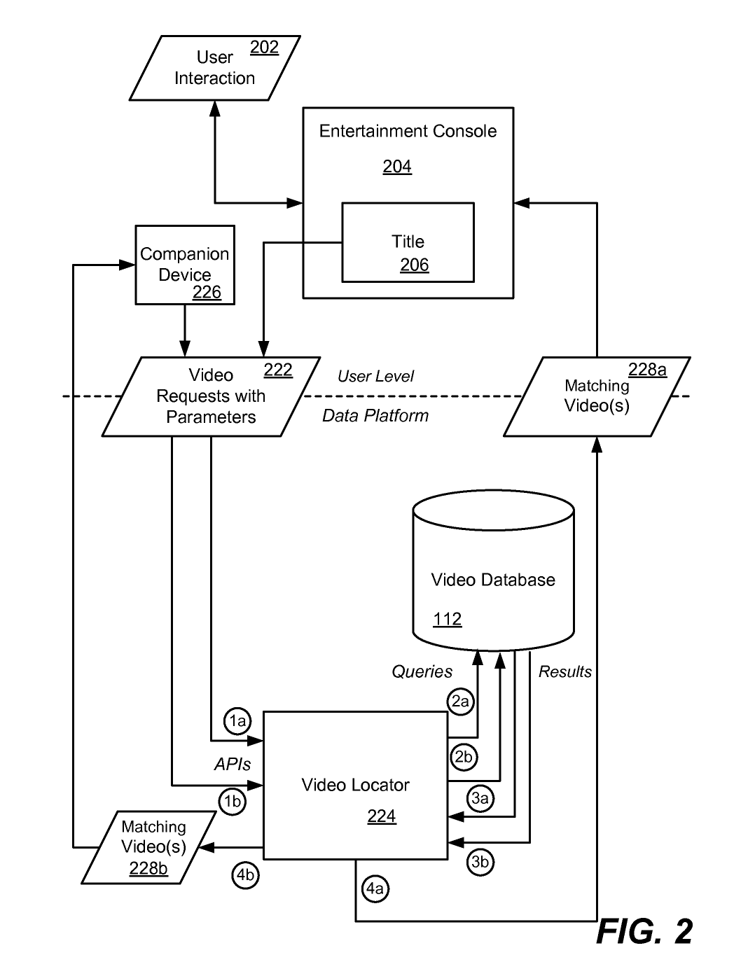

Turning to retrieving the video based upon the associated event metadata, as represented in FIG. 2, the system (data platform) provides one or more APIs or the like for applications (e.g., a title 206 running in a console 204 to make one or more requests 222 for video as needed. This is represented in FIG. 2 by the arrows (1a)-(4a). This may be as a result of direct user action (block 202), such as if the user wants to see part of a past game video, or a friend's video. A user also may request a video during game play, such as directly via an interactive element in a game, or indirectly, e.g., when asking for help. A request may be made automatically as part of game play. For example, a user may trigger a request and subsequent video clip playback upon entering a room.

Note that the user is not necessarily the same user corresponding to the video's creation. Further, the title need not be the same game. For example, a separate title (or dashboard component) may be provided for interfacing with the data platform simply to view videos, without any game being played. Such a title or component may automatically convert user requests or the like (“see my friend Joe's last ten kills”) to the actual parameters (one or more search criteria corresponding to the video's metadata) by which the corresponding video clip or clips are searched and retrieved.

The one or more requests 222 (or at least one) may be made by a companion device 226 (or multiple companion devices). This is represented in FIG. 2 by the arrows (1b)-(4b). For example, a user may pause a game or get to a holding position and request via a smartphone or tablet computing device that a video be retrieved and returned (e.g., streamed) for playback. The requesting device need not be the same as the receiving device; for example, a user may interact with the game console 204 to send a request, specifying that a video to be sent to the companion device (or vice-versa).

When a request is received, the parameters corresponding to the video's metadata are provided by the requesting entity. By way of example, consider a user who asks for help while in a certain location in a game's map. The parameters may include the game character's x, y, z, coordinates, by which a video or set of videos is returned. Such a video may, for example, show how an adversary was overcome by another user. Another type of help is to show the user a video (e.g., generated by another user) of surrounding scenes or options to take when the user is lost.

The video requests/parameters correspond to or may be in the form of database queries. By way of example, some various queries are set forth below, and may include “Player Section Exit Queries,” such as queries to “return the Halo® videos to me where my friends completed <section id> on <difficulty level>,” “return all the race game videos where my friends failed <section id> on <difficulty level>.

“Multiplayer Instance Exit Queries” may include queries derived from some request like “return all the videos of my friends who were in <my same multiplayer session>.” “Objective Updated Queries” may include queries derived from some request like “Return all the videos of my friends where they completed <ObjectiveID>”.

“Location-Based Queries” may request the system to “Sort all the public videos by distance from <location X, Y, Z>,” for example. This allows a user to see the videos of others (or possibly the user from a previous game) who were close to the user's specified position, from the point of view of the other user (which may be different from the current user's point of view.

“Element-in-Common Queries” search videos from multiple different titles where there is some element in common, e.g., “Return all of the videos of my friends where they complete an objective wearing chain-mail armor.” “Just Like Me” queries generally take a significant amount of information about the player, e.g., armor, inventory, level, location and so forth, and return videos that are of other players in similar situations. These may be used for “game help” scenarios, where the user would like to see how other people who have similar attributes have completed a task he or she is attempting to complete, and/or be given help corresponding to one or more others who had a similar or close XYZ location.

If the metadata is available, queries may be from a perspective or direction, e.g., videos looking in a certain direction, videos of players walking West. Temporal and/or current game state may be factored in to which video or videos are selected, e.g., in a quest-type game, one user may not see a video in which a treasure is shown because the user has not yet earned that level through some accomplishment, while another user may see such a video.

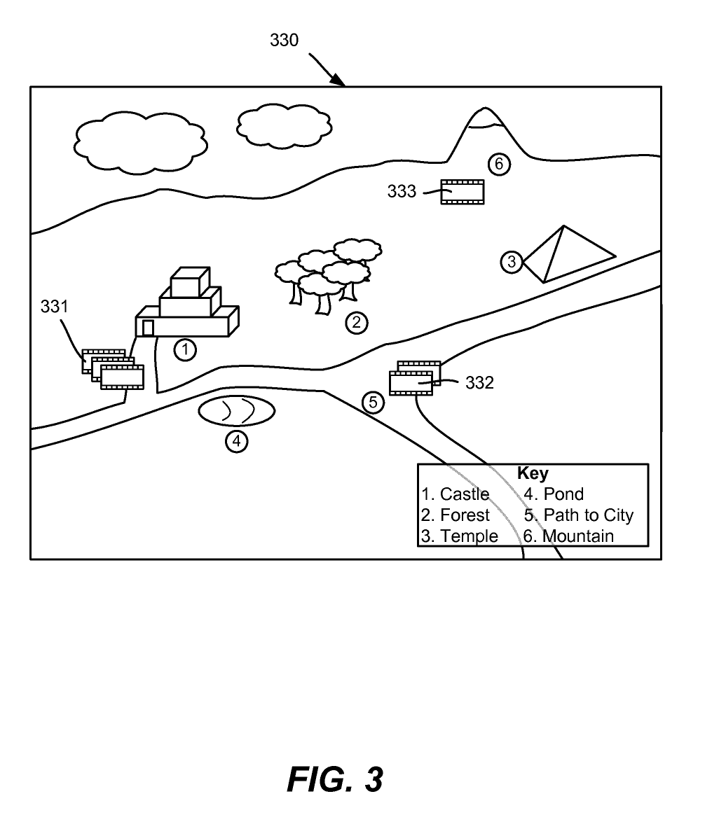

FIG. 3 shows one example implementation of game-generated videos overlaid on a map 330. As the user moves around the map, relevant videos may appear, such as in the form of interactive icons (e.g., 331-333), e.g., based upon the user's current coordinates, achievement level, and so on. These videos may be multiple videos at a location, and/or may be prioritized as needed in any suitable way, e.g., based on whether they belong to friends, how similar the player in the video is to the current player in terms of skill or the like, and so forth, which may be user configurable. Such information was contained in the metadata when those previous videos were generated, with the metadata associated to the videos as described herein.

Many other usage models are feasible. For example, a user may be given an option to re-live moments in various recently played worlds.

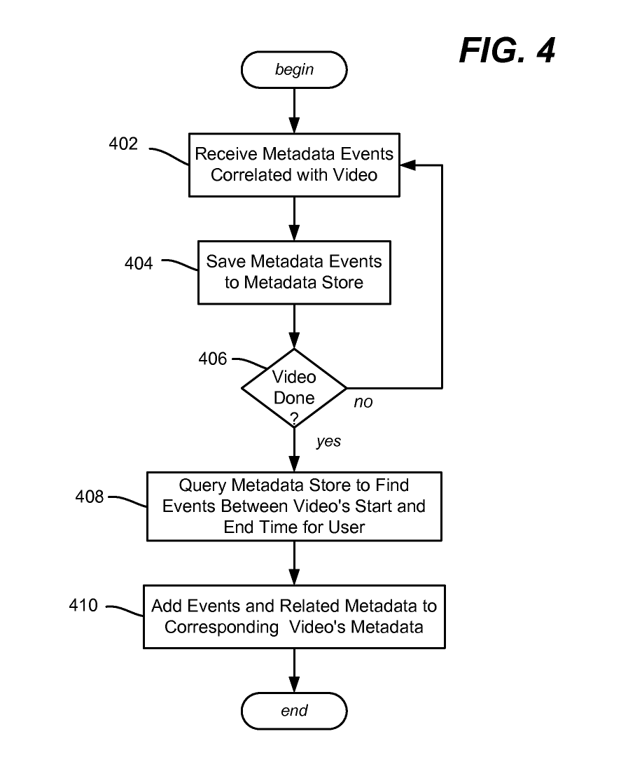

FIG. 4 is a flow diagram summarizing example steps related to receiving and handling event metadata, beginning at step 402 wherein metadata events, correlated with a video by video ID and user ID, are received. Step 404 saves the metadata events to the metadata store. Note that filtering of non-video related events may occur at this point, if desired.

When the video is done (or at some other suitable point, such as if a video is divided into clips and a clip is done) as evaluated at step 406, step 408 queries metadata store, e.g., to find those events between video's start and end time for the user's video. It is feasible to perform such filtering here as well, e.g., one component may log all events, and another component may filter only those related to video for adding to the video's metadata. Step 410 represents the adding of the events and their accompanying metadata to the corresponding video's metadata.

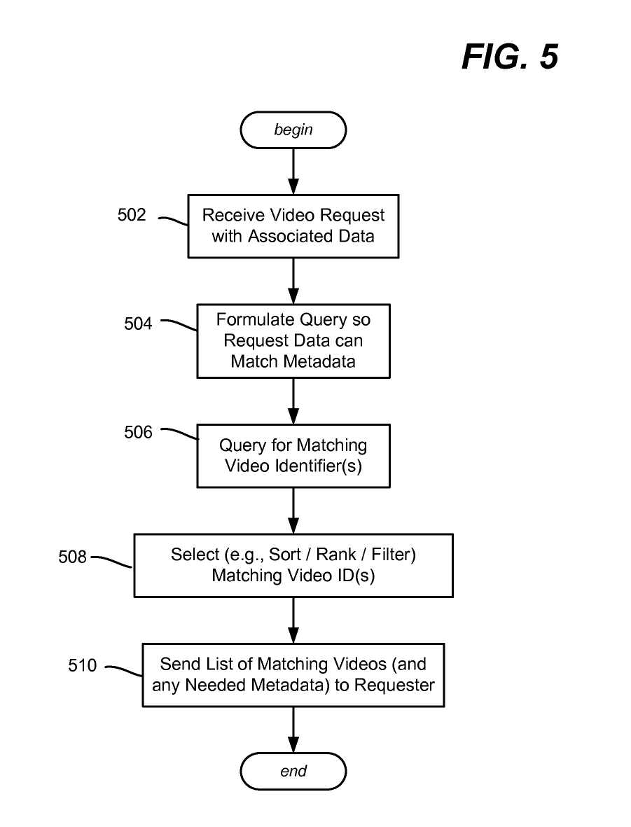

FIG. 5 is a flow diagram summarizing example steps related to searching for relevant videos based upon a received request (step 502). As described above, requests may come in various forms, including plain language requests, requests suggested by a title, and so on. Step 504 represents formulating a query, e.g., so that it is in the proper form for matching with the video's associated metadata. Step 506 submits the query, seeking a video identifier of each video (and possibly some of its associated metadata, such as used for sorting).

Step 508 represents selecting the video or videos to return, e.g., as a list of video identifiers. Depending on the query, some filtering may need to be done, for example if the query was not sufficiently narrow. Sorting and/or ranking may be done as part of the selection process. For example, “Sort all the public videos by distance” may need a sort operation after the retrieval operation. Note that a query may be reformulated, e.g., “Sort all the public videos by distance” may result in too many videos being identified via the corresponding query, and thus some distance limit may be specified in the query, e.g., retrieve the public videos by distance within ten yards of these coordinates. However, this may not result in a sufficient number, and thus a larger radius may be provided in a reformulated query until some threshold number of identified videos is met.

Step 510 sends the list of matching videos to the requester, which as set forth above may be to a different device. The list may also include some or all of the metadata (or data derived from the metadata). For example, in FIG. 3, the locations of returned videos in the map's coordinate space need to be returned so that they can be positioned properly on the map.

Note that returned videos need not be limited to the same title from which they were generated. For example, a user may request to see his friends' videos from multiple titles where his friend did something noteworthy, such as won a race, beat a boss and so on.

### Example Event Information

The following sets forth some possible examples of events; more may be present than those shown, and not all those shown need be present. One or more implementations allow title developers to create custom events as well.

| | |
|---|---|
| PlayerSessionStart | Call when a user begins interacting with the title |
| | in a specific mode or experience. |
| Fields: | User Stats: |
| UserId | {Title}.CurrentMode |
| (xuid) | {Title}.CurrentDifficulty |
| PlayerSessionId | {Title}.CurrentPlayerSession |
| (guid) | {Title}.PlayerSessionStartTime |
| MultiplayerSessionId | {Title}.SessionsStarted |
| (guid) | {Title}.SessionsStarted.Mode.{GameplayMode} |
| GameplayMode | {Title}.SessionsStarted.Difficulty. |
| (int) | {DifficultyLevelId} |
| DifficultyLevelId | |
| (enum int) | |

| | |
|---|---|
| PlayerSessionPause | This event is fired when the title goes into idle |
| | mode or the player enters an area of the game or |
| | app that is not relevant to include in the total time |
| | actively spent in the title. The goal is to provide |
| | useful information to the player about the amount |
| | of time they've actually played a game or used an |
| | app. |
| Fields: | User Stats: |
| UserId | {Title\|Genre\|XBL}.MinutesPlayed |
| (xuid) | |
| PlayerSessionId | |
| (guid) | |

| | |
|---|---|
| PlayerSessionResume | This event is fired when the title resumes from |
| | idle mode or the player enters an area of the game |
| | or app that is relevant to include in the total time |
| | actively spent in the title. |
| Fields: | User Stats: |
| UserId | {Title}.CurrentMode |
| (xuid) | {Title}.CurrentDifficulty |
| PlayerSessionId | {Title}.PlayerSessionStartTime |
| (guid) | |
| MultiplayerSessionId | |
| (guid) | |
| GameplayMode | |
| (int) | |
| DifficultyLevelId | |
| (enum int) | |

| | |
|---|---|
| PlayerSessionEnd | Call when a user exits the current Player Session |
| | or quits the game, or simply navigates away from |
| | the specific experience it was previously |
| | interacting with the title. |
| Fields | User Stats: |
| UserId | {Title}.SessionsCompleted |
| (xuid) | {Title}.SessionsCompleted.ExitStatus. |
| PlayerSessionId | {ExitStatusId} |
| (guid) | {Title}.SessionsCompleted.Difficulty. |
| MultiplayerSessionId | {DifficultyLevelId} |
| (guid) | {Title}.SessionCompleted.Mode. |
| GameplayMode | {GameplayMode} |
| (int) | {Title}.SessionCompleted.Mode. |
| DifficultyLevelId | {GameplayMode}.Difficulty.{DifficultyLevelId} |
| (enum int) | {Title\|Genre\|XBL}.MinutesPlayed |
| ExitStatusId | |
| (enum int) | |

| | |
|---|---|
| SectionStart | Call when a user enters a distinct major thematic |
| | or narrative section of the game. Examples of a |
| | “section” are maps, levels, worlds, chapters, etc. |
| | Sections can also include menus, lobbies, as |
| | appropriate. CurrentSection will be used |
| Fields: | User Stats: |
| UserId | {Title}.CurrentSection |
| (xuid) | {Title}.SectionsStarted |
| SectionId | {Title}.SectionsStarted.Mode.{GameplayMode} |
| (int) | {Title}.SectionsStarted.Section.{SectionId} |
| PlayerSessionId | {Title}.SectionsStarted.Difficulty. |
| (guid) | {DifficultyLevelId} |
| MultiplayerSessionId | |
| (guid) | |
| GameplayMode | |
| (int) | |
| DifficultyLevelId | |
| (enum int) | |

| | |
|---|---|
| SectionEnd | Call when a user successfully or unsuccessfully |
| | exits a distinct major thematic or narrative section |
| | of the game. Fire this event when a player |
| | completes a narrative, quits the game, dies, or |
| | simply navigates away from a specific area or |
| | world. |
| Fields: | User Stats: |
| UserId | {Title}.SectionsCompleted |
| (xuid) | {Title}.SectionsCompleted.Difficulty. |
| SectionId | {DifficultyLevelId} |
| (int) | {Title}.SectionCompleted.Section{SectionId} |
| PlayerSessionId | {Title}.SectionCompleted.Section.{SectionId}. |
| (guid) | Difficulty.{DifficultyLevelId} |
| MultiplayerSessionId | {Title}.SectionCompleted.Mode. |
| (guid) | {GameplayMode} |
| GameplayMode | {Title}.SectionCompleted.Mode. |
| (int) | {GameplayMode}. |
| DifficultyLevelId | Difficulty.{DifficultyLevelId} |
| (enum int) | {Title}.SectionsFailed |
| ExitStatusId | {Title}.SectionsFailed.Difficulty. |
| (enum int) | {DifficultyLevelId} |
| | {Title}.SectionFailed.Section.{SectionId} |
| | {Title}.SectionFailed.Section.{SectionId}. |
| | Difficulty.{DifficultyLevelId} |
| | {Title}.SectionFailed.Mode.{GameplayMode} |
| | {Title}.SectionFailed.Section{SectionId}. |
| | Difficulty.{DifficultyLevelId} |
| | {Title}. SectionFailed.Mode.{GameplayMode}. |
| | Difficulty.{DifficultyLevelId} |

| | |
|---|---|
| MultiplayerRoundStart | This event is to be fired when a player enters a |
| | ranked or match-made multiplayer round. A |
| | round is an instance of gameplay that ends with |
| | winners and losers. |
| | Differentiates between competitive vs. |
| | cooperative modes, and public vs. private |
| | matchmaking. |
| Fields: | User Stats: |
| UserId | {Title\|Genre\|XBL}.RoundsStarted |
| (xuid) | {Title\|Genre\|XBL}.RoundsStarted. |
| RoundId | Difficulty.{DifficultyLevelId} |
| (guid) | {Title\|Genre\|XBL}.RoundsStarted.Mode. |
| SectionId | {GameplayMode} |
| (int) | {Title}.RoundsStarted.Section.{SectionId} |
| PlayerSessionId | |
| (guid) | |
| MultiplayerSessionId | |
| (guid) | |
| GameplayMode | |
| (int) | |
| MatchType | |
| (int) | |
| DifficultyLevelId | |
| (enum int) | |

| | |
|---|---|
| MultiplayerRoundEnd | This event is to be fired when a player exits a |
| | ranked or match-made multiplayer round. The |
| | goal is to collect information about the |
| | competitive rounds a user plays. |
| Fields: | User Stats: |
| UserId | {Title\|Genre\|XBL}.RoundsCompleted |
| (xuid) | {Title\|Genre\|XBL}.RoundsCompleted.Difficulty. |
| RoundId | {DifficultyLevelId} |
| (guid) | {Title\|Genre\|XBL}.RoundsCompleted.ExitStatus. |
| SectionId | {ExitStatusId} |
| (int) | {Title\|Genre\|XBL}.RoundsCompleted.Difficulty. |
| PlayerSessionId | {DifficultyLevelId}.ExitStatus.{ExitStatusId} |
| (guid) | {Title\|Genre\|XBL}.RoundsCompleted.Mode. |
| MultiplayerSessionId | {GameplayMode} |
| (guid) | {Title\|Genre\|XBL}.RoundsCompleted.Mode. |
| GameplayMode | {GameplayMode}.{ExitStatusId} |
| (int) | {Title}.RoundsCompleted.Section.{SectionId} |
| DifficultyLevelId | {Title}.RoundsCompleted.Section.{SectionId}. |
| (enum int) | ExitStatus.{ExitStatusId} |
| RoundDuration | |
| (int) | |
| ExitStatusId | |
| (enum int) | |

| | |
|---|---|
| GameProgress | This event is logged each time a player hits an in- |
| | game progression marker |
| Fields: | User Stats: |
| UserId | {Title}.GameProgress |
| (xuid) | |
| CompletionPercent | |
| (float) | |

| | |
|---|---|
| GameClipCreated | This event is logged each time a player creates an |
| | in-game video clip |
| Fields: | User Stats: |
| UserId | {Title\|Genre\|XBL}.GameClips |
| (xuid) | |
| SectionId | |
| (int) | |
| PlayerSessionId | |
| (guid) | |
| MultiplayerSessionId | |
| (guid) | |
| GameplayMode | |
| (int) | |
| DifficultyLevelId | |
| (enum int) | |
| ObjectiveId | |
| (int) | |
| ExitStatusId | |
| (enum int) | |
| LocationX | |
| (float) | |
| LocationY | |
| (float) | |
| LocationZ | |
| (float) | |
| GameClipId | |
| (guid) | |

In-Game Genre Events are for titles that belong to the corresponding genre, e.g., Racing, Action & Adventure, Shooter, Sports & Recreation, Fighter, and so on. Any title can optionally log these events regardless of their genre if there are game mechanics which make them applicable, and the technology described herein may use them as desired.

| | |
|---|---|
| ObjectiveStart | Call each time a player starts or completes an |
| | in-game objective, quest, mission, or goal. |
| Fields: | {Title}.ObjectiveStarted.{ObjectiveId} |
| UserId | {Title\|Genre\|XBL}.ObjectivesStarted |
| (xuid) | {Title\|Genre\|XBL}.MajorObjectivesStarted |
| SectionId | {Title\|Genre\|XBL}.MinorObjectivesStarted |
| (int) | |
| PlayerSessionId | |
| (guid) | |
| MultiplayerSessionId | |
| (guid) | |
| GameplayMode | |
| (int) | |
| DifficultyLevelId | |
| (enum int) | |
| ObjectiveId | |
| (int) | |

| | |
|---|---|
| ObjectiveEnd | Call each time a player starts or completes an in- |
| | game objective, quest, mission, or goal. |
| Fields: | {Title}.ObjectiveCompleted.{ObjectiveId} |
| UserId | {Title\|Genre\|XBL}.ObjectivesCompleted |
| (xuid) | {Title\|Genre\|XBL}.ObjectivesCompleted. |
| SectionId | Difficulty.{DifficultyLevelId} |
| (int) | {Title\|Genre\|XBL}.MajorObjectivesCompleted |
| PlayerSessionId | {Title\|Genre\|XBL}.MinorObjectivesCompleted |
| (guid) | |
| MultiplayerSessionId | |
| (guid) | |
| GameplayMode | |
| (int) | |
| DifficultyLevelId | |
| (enum int) | |
| ObjectiveId | |
| (int) | |
| ExitStatusId | |
| (enum int) | |

| | |
|---|---|
| EnemyDefeated | Call each time a player defeats an enemy |
| Fields: | User Stats: |
| UserId | {Title\|Genre\|XBL}.EnemyDefeats |
| (xuid) | {Title\|Genre\|XBL}.EnemyDefeats.Difficulty. |
| SectionId | {DifficultyLevelId} |
| (int) | {Title\|Genre\|XBL}.EnemyDefeats.Weapon. |
| PlayerSessionId | {PlayerWeaponId} |
| (guid) | {Title\|Genre\|XBL}.EnemyDefeats.Enemy. |
| MultiplayerSessionId | {EnemyRoleId} |
| (guid) | {Title\|Genre\|XBL}.EnemyDefeats.Mode. |
| GameplayMode | {GameplayMode} |
| (int) | {Title}.EnemyDefeats.Section.{SectionId} |
| DifficultyLevelId | {Title\|Genre\|XBL}.EnemyDefeats.KillType. |
| (enum int) | {KillType} |
| RoundId | {Title}.LastEnemyDefeattX |
| (guid) | {Title}.LastEnemyDefeatY |
| PlayerRoleId | {Title}.LastEnemyDefeatZ |
| (int) | {Title}.LocationX |
| PlayerWeaponId | {Title}.LocationY |
| (int) | {Title}.LocationZ |
| EnemyRoleId | |
| (int) | |
| KillType | |
| (enum int) | |
| LocationX | |
| (float) | |
| LocationY | |
| (float) | |
| LocationZ | |
| (float) | |

| | |
|---|---|
| PlayerDefeated | Call each time the player is defeated in the |
| | game. |
| Fields: | User Stats: |
| UserId | {Title\|Genre\|XBL}.PlayerDefeats |
| (xuid) | {Title\|Genre\|XBL}.PlayerDefeats.Difficulty. |
| SectionId | {DifficultyLevelId} |
| (int) | {Title\|Genre\|XBL}.PlayerDefeats.Weapon. |
| PlayerSessionId | {PlayerWeaponId} |
| (guid) | {Title\|Genre\|XBL}.PlayerDefeats.Enemy. |
| MultiplayerSessionId | {EnemyRoleId} |
| (guid) | {Title\|Genre\|XBL}.PlayerDefeats.Mode. |
| GameplayMode | {GameplayMode} |
| (int) | {Title}.PlayerDefeats.Section.{SectionId} |
| DifficultyLevelId | {Title}.LastPlayerDefeatX |
| (enum int) | {Title}.LastPlayerDefeatY |
| RoundId | {Title}.LastPlayerDefeatZ |
| (guid) | {Title}.LocationX |
| PlayerRoleId | {Title}.LocationY |
| (int) | {Title}.LocationZ |
| PlayerWeaponId | |
| (int) | |
| EnemyRoleId | |
| (int) | |
| LocationX | |
| (float) | |
| LocationY | |
| (float) | |
| LocationZ | |
| (float) | |

| | |
|---|---|
| PlayerSpawned | Call each time a player is created or re-created |
| | in game. |
| Fields: | User Stats: |
| UserId | {Title\|Genre\|XBL}.Spawns |
| (xuid) | {Title\|Genre\|XBL}.Spawns.Difficulty. |
| SectionId | {DifficultyLevelId} |
| (int) | {Title\|Genre\|XBL}.Spawns. |
| PlayerSessionId | Mode{GameplayMode} |
| (guid) | {Title}.Spawns.Section.{SectionId} |
| MultiplayerSessionId | {Title}.LastSpawnX |
| (guid) | {Title}.LastSpawnY |
| GameplayMode | {Title}.LastSpawnZ |
| (int) | {Title}.LocationX |
| DifficultyLevelId | {Title}.LocationY |
| (enum int) | {Title}.LocationZ |
| RoundId | |
| (guid) | |
| PlayerRoleId | |
| (int) | |
| LocationX | |
| (float) | |
| LocationY | |
| (float) | |
| LocationZ | |
| (float) | |

| | |
|---|---|
| SongPerformed | Call each time a player completes a song. |
| Fields: | User Stats: |
| UserId | {Title\|Genre\|XBL}.SongsPerformed |
| (xuid) | {Title\|Genre\|XBL}.SongsPerformed.Role. |
| SectionId | {PlayerRoleId} |
| (int) | {Title\|Genre\|XBL}.SongsPerformed.Difficulty. |
| PlayerSessionId | {DifficultyLevelId} |
| (guid) | {Title\|Genre\|XBL}.SongsPerformed.Role. |
| MultiplayerSessionId | {PlayerRoleId}.Difficulty.{DifficultyLevelId} |
| (guid) | |
| GameplayMode | |
| (int) | |
| DifficultyLevelId | |
| (enum int) | |
| RoundId | |
| (guid) | |
| PlayerRoleId | |
| (int) | |

| | |
|---|---|
| RaceStart | Call every time a player begins a race in the |
| | game. |
| Fields: | User Stats: |
| UserId | {Title}.CurrentVehicle |
| (xuid) | {Title}.RacesStarted.Section.{SectionId} |
| SectionId | {Title}.RacesStarted.Mode.{GameplayMode} |
| (int) | {Title}.RacesStarted.Vehicle.{VehicleId} |
| PlayerSessionId | {Title\|Genre\|XBL}.RacesStarted |
| (guid) | {Title\|Genre\|XBL}.RacesStarted.Difficulty. |
| MultiplayerSessionId | {DifficultyLevelId} |
| (guid) | |
| GameplayMode | |
| (int) | |
| DifficultyLevelId | |
| (enum int) | |
| RoundId | |
| (guid) | |
| VehicleId | |
| (int) | |

| | |
|---|---|
| RaceEnd | Call every time a player finishes a race in the |
| | game. |
| Fields: | User Stats: |
| UserId | {Title}.RacesCompleted.Section.{SectionId} |
| (xuid) | {Title}.RacesCompleted.Section.{SectionId} |
| SectionId | Section.{SectionId}.Difficulty. |
| (int) | {DifficultyLevelId} |
| PlayerSessionId | {Title}.RacesCompleted.Mode.{GameplayMode} |
| (guid) | {Title}.RacesCompleted.Vehicle.{VehicleId} |
| MultiplayerSessionId | {Title\|Genre\|XBL}.RacesCompleted |
| (guid) | {Title\|Genre\|XBL}.RacesCompleted.Difficulty. |
| GameplayMode | {DifficultyLevelId} |
| (int) | {Title\|Genre\|XBL}.RacesCompleted.ExitStatus. |
| DifficultyLevelId | {ExitStatusId} |
| (enum int) | {Title\|Genre\|XBL}.RacesCompleted.Difficulty. |
| RoundId | {DifficultyLevelId}.ExitStatus{ExitStatusId} |
| (guid) | |
| VehicleId | |
| (int) | |
| ExitStatusId | |
| (enum int) | |
| Time | |
| (int) | |
| Place | |
| (int) | |

| | |
|---|---|
| PuzzleSolved | Call when a puzzle is solved successfully |
| Fields: | User Stats: |
| UserId | {Title\|Genre\|XBL}.PuzzlesSolved |
| (xuid) | {Title\|Genre\|XBL}.PuzzlesSolved.Difficulty. |
| SectionId | {DifficultyLevelId} |
| (int) | {Title}. PuzzlesSolved.Section.{SectionId} |
| PlayerSessionId | |
| (guid) | |
| GameplayMode | |
| (int) | |
| DifficultyLevelId | |
| (enum int) | |
| Time | |
| (int) | |

| | |
|---|---|
| ItemAcquired | Call when a user acquires an item, collectible or |
| | object that changes their characteristics, can be |
| | consumed to change their characteristics, or |
| | advances a narrative in gameplay. |
| Fields: | User Stats: |
| UserId | {Title\|Genre\|XBL}.ItemsAcquired |
| (xuid) | {Title}.ItemsAcquired.Section.{SectionId} |
| SectionId | {Title}.ItemsAcquired.Item.{ItemId} |
| (int) | {Title}.LocationX |
| PlayerSessionId | {Title}.LocationY |
| (guid) | {Title}.LocationZ |
| MultiplayerSessionId | |
| (guid) | |
| GameplayMode | |
| (int) | |
| DifficultyLevelId | |
| (enum int) | |
| ItemId | |
| (int) | |
| AcquisitionMethod | |
| (int) | |
| LocationX | |
| (float) | |
| LocationY | |
| (float) | |
| LocationZ | |
| (float) | |

| | |
|---|---|
| ItemUsed | Call each time a player uses an item that they |
| | have previously acquired. |
| Fields: | User Stats: |
| UserId | {Title\|Genre\|XBL}.ItemsUsed |
| (xuid) | {Title}.ItemsUsed.Section.{SectionId} |
| SectionId | {Title}.ItemsUsed.Item.{ItemId} |
| (int) | {Title}.LocationX |
| PlayerSessionId | {Title}.LocationY |
| (guid) | {Title}.LocationZ |
| MultiplayerSessionId | |
| (guid) | |
| GameplayMode | |
| (int) | |
| DifficultyLevelId | |
| (enum int) | |
| ItemId | |
| (int) | |
| LocationX | |
| (float) | |
| LocationY | |
| (float) | |
| LocationZ | |
| (float) | |

### Example Operating Environment

It can be readily appreciated that the above-described implementation and its alternatives may be implemented on any suitable computing device, including a gaming system, personal computer, tablet, DVR, set-top box, smartphone and/or the like. Combinations of such devices are also feasible when multiple such devices are linked together. For purposes of description, a gaming (including media) system is described as one exemplary operating environment hereinafter.

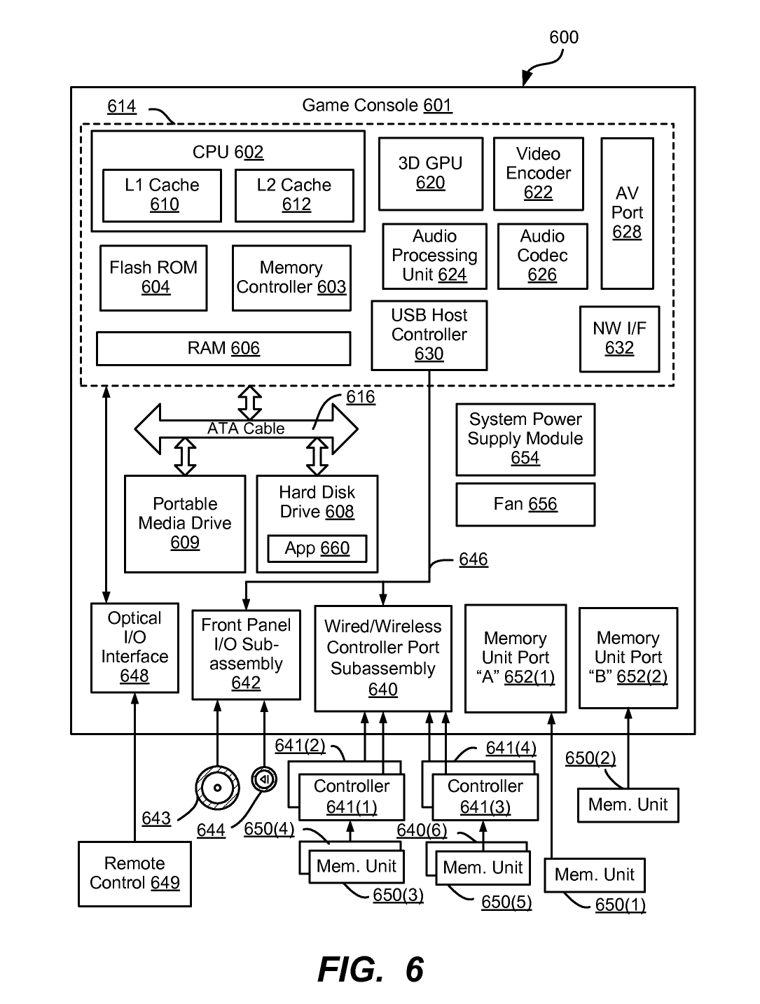

FIG. 6 is a functional block diagram of an example gaming and media system 600 and shows functional components in more detail. Console 601 has a central processing unit (CPU) 602, and a memory controller 603 that facilitates processor access to various types of memory, including a flash Read Only Memory (ROM) 604, a Random Access Memory (RAM) 606, a hard disk drive 608, and portable media drive 609. In one implementation, the CPU 602 includes a level 1 cache 610, and a level 2 cache 612 to temporarily store data and hence reduce the number of memory access cycles made to the hard drive, thereby improving processing speed and throughput.

The CPU 602, the memory controller 603, and various memory devices are interconnected via one or more buses (not shown). The details of the bus that is used in this implementation are not particularly relevant to understanding the subject matter of interest being discussed herein. However, it will be understood that such a bus may include one or more of serial and parallel buses, a memory bus, a peripheral bus, and a processor or local bus, using any of a variety of bus architectures. By way of example, such architectures can include an Industry Standard Architecture (ISA) bus, a Micro Channel Architecture (MCA) bus, an Enhanced ISA (EISA) bus, a Video Electronics Standards Association (VESA) local bus, and a Peripheral Component Interconnects (PCI) bus also known as a Mezzanine bus.

In one implementation, the CPU 602, the memory controller 603, the ROM 604, and the RAM 606 are integrated onto a common module 614. In this implementation, the ROM 604 is configured as a flash ROM that is connected to the memory controller 603 via a Peripheral Component Interconnect (PCI) bus or the like and a ROM bus or the like (neither of which are shown). The RAM 606 may be configured as multiple Double Data Rate Synchronous Dynamic RAM (DDR SDRAM) modules that are independently controlled by the memory controller 603 via separate buses (not shown). The hard disk drive 608 and the portable media drive 609 are shown connected to the memory controller 603 via the PCI bus and an AT Attachment (ATA) bus 616. However, in other implementations, dedicated data bus structures of different types can also be applied in the alternative.

A three-dimensional graphics processing unit 620 and a video encoder 622 form a video processing pipeline for high speed and high resolution (e.g., High Definition) graphics processing. Data are carried from the graphics processing unit 620 to the video encoder 622 via a digital video bus (not shown). An audio processing unit 624 and an audio codec (coder/decoder) 626 form a corresponding audio processing pipeline for multi-channel audio processing of various digital audio formats. Audio data are carried between the audio processing unit 624 and the audio codec 626 via a communication link (not shown). The video and audio processing pipelines output data to an A/V (audio/video) port 628 for transmission to a television or other display/speakers. In the illustrated implementation, the video and audio processing components 620, 622, 624, 626 and 628 are mounted on the module 614.

FIG. 6 shows the module 614 including a USB host controller 630 and a network interface (NW I/F) 632, which may include wired and/or wireless components. The USB host controller 630 is shown in communication with the CPU 602 and the memory controller 603 via a bus (e.g., PCI bus) and serves as host for peripheral controllers 634. The network interface 632 provides access to a network (e.g., Internet, home network, etc.) and may be any of a wide variety of various wire or wireless interface components including an Ethernet card or interface module, a modem, a Bluetooth module, a cable modem, and the like.

In the example implementation depicted in FIG. 6, the console 601 includes a controller support subassembly 640, for supporting four game controllers 641(1)-641(4). The controller support subassembly 640 includes any hardware and software components needed to support wired and/or wireless operation with an external control device, such as for example, a media and game controller. A front panel I/O subassembly 642 supports the multiple functionalities of a power button 643, an eject button 644, as well as any other buttons and any LEDs (light emitting diodes) or other indicators exposed on the outer surface of the console 601. The subassemblies 640 and 642 are in communication with the module 614 via one or more cable assemblies 646 or the like. In other implementations, the console 601 can include additional controller subassemblies. The illustrated implementation also shows an optical I/O interface 648 that is configured to send and receive signals (e.g., from a remote control 649) that can be communicated to the module 614.

Memory units (MUs) 650(1) and 650(2) are illustrated as being connectable to MU ports “A” 652(1) and “B” 652(2), respectively. Each MU 650 offers additional storage on which games, game parameters, and other data may be stored. In some implementations, the other data can include one or more of a digital game component, an executable gaming application, an instruction set for expanding a gaming application, and a media file. When inserted into the console 601, each MU 650 can be accessed by the memory controller 603.

A system power supply module 654 provides power to the components of the gaming system 600. A fan 656 cools the circuitry within the console 601.

An application 660 comprising machine instructions is typically stored on the hard disk drive 608. When the console 601 is powered on, various portions of the application 660 are loaded into the RAM 606, and/or the caches 610 and 612, for execution on the CPU 602. In general, the application 660 can include one or more program modules for performing various display functions, such as controlling dialog screens for presentation on a display (e.g., high definition monitor), controlling transactions based on user inputs and controlling data transmission and reception between the console 601 and externally connected devices.

The gaming system 600 may be operated as a standalone system by connecting the system to high definition monitor, a television, a video projector, or other display device. In this standalone mode, the gaming system 600 enables one or more players to play games, or enjoy digital media, e.g., by watching movies, or listening to music. However, with the integration of broadband connectivity made available through the network interface 632, gaming system 600 may further be operated as a participating component in a larger network gaming community or system.

### CONCLUSION

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. A computer-implemented method, comprising, receiving event metadata corresponding to game play for which a video is generated, locating video-related metadata of the video, and associating at least some of the event metadata with the video-related metadata of the video.

2. The method of claim 1 further comprising, logging the event metadata and receiving en event indicating that the video is done, and wherein locating the video-related metadata of the video and associating at least some of the event metadata with the video-related metadata comprises inserting at least some of the logged event metadata into a database of video identifiers and metadata.

3. The method of claim 2 wherein inserting the logged event metadata into the database comprises adding at least some of the event metadata to existing metadata associated with that video.

4. The method of claim 1 further comprising, receiving a request for one or more videos, and querying for the one or more videos based upon the event metadata associated with the videos.

5. The method of claim 4 further comprising, formulating a query corresponding to a format of the event metadata.

6. The method of claim 4 further comprising, receiving data corresponding to one or more videos in response to the querying, and returning the data in response the request.

7. The method of claim 6 further comprising, returning at least some metadata in response the request.

8. The method of claim 6 further comprising, sorting a plurality of video identifiers received in response to the querying.

9. The method of claim 6 further comprising, returning the data to a device that is different from a device that provided the request.

10. A system comprising, a video and event metadata connector, the video and event metadata connector configured to associate metadata events corresponding to video game play with video content generated during that game play, and a video locator, the video locator configured to query for one or more video identifiers that match a request for video content based upon event metadata that is associated with the video content by the video and event metadata connector.

11. The system of claim 10 wherein the query for one or more video identifiers is based upon a category of requests, the category corresponding to player section exit queries, multiplayer instance exit queries or objective updated queries.

12. The system of claim 10 wherein the query for one or more video identifiers is based upon a category of requests corresponding to location-based queries.

13. The system of claim 10 wherein the query for one or more video identifiers is based upon a category of requests, the category corresponding to element-in-common queries or just like me queries.

14. The system of claim 10 further comprising, receiving the request for video content to satisfy a user-help request.

15. The system of claim 10 further comprising, receiving the request for video content based upon a user's location in a game.

16. The system of claim 10 wherein the request for video content is initiated during game play, and wherein the request specifies that a response be sent to a companion device.

17. The system of claim 10 wherein the query for one or more video identifiers is for video identifiers of video generated from different titles.

18. One or more machine-readable storage media or logic having executable instructions, which when executed perform steps, comprising receiving a request for video content that was generated during the playing of a video game, searching for the video content based upon on or more search criteria provided via the request and event metadata that was produced during playing of the video game, and returning one or more video identifiers of video having event metadata that matches the one or more search criteria in response to the request.

19. The one or more machine-readable storage media or logic of claim 18 having further executable instructions comprising, associating at least some event metadata that is produced during playing of a video game with video content generated during the playing of the video game.

20. The one or more machine-readable storage media or logic of claim 18 having further executable instructions comprising further computer-executable instructions comprising, returning at least some event metadata in response to the request.
